(19) United States
(12) Patent Application Publication
(10) Pub. No.: US 2007/0189343 A1
(43) Pub. Date: Aug. 16, 2007

(54) White light solid-state laser source with adjustable RGB output

(76) Inventors: Wolf Seelert, Lubeck (DE); Andreas Diening, Lubeck (DE)

Correspondence Address: STALLMAN & POLLOCK LLP, 353 SACRAMENTO STREET, SUITE 2200, SAN FRANCISCO, CA, 94111, US

(21) Appl. No.: 11/353,357

(22) Filed: Feb. 14, 2006

(51) Int. Cl. H01S 3/10; H01S 3/093

(52) U.S. Cl. 372/22; 372/72

(57) ABSTRACT

Red light and green light are generated by passing portions of a beam of plane-polarized blue light through two resonators each including a praseodymium-doped gain-medium. One of the resonators generates green light and the other resonator generates red light in response to absorption of the blue light by the gain-medium. The amount of green or red light generated can be varied by varying the orientation of the polarization-plane of the blue light with respect to the gain-medium. The red light, green light, and a portion of the blue light not absorbed by the gain-media can be combined to form a beam of white light, or a beam of light of a predetermined color.

### TECHNICAL FIELD OF THE INVENTION

The present invention relates in general to generating diode-laser pumped, solid-state lasers. The invention relates in particular to generating red and green laser radiation from a solid-state gain-medium optically pumped by radiation from a semiconductor laser emitting blue radiation.

### DISCUSSION OF BACKGROUND ART

It is well known that visible laser radiation having a particular color can be provided by combining red, green, and blue laser beams. The range of colors that can be provided depends, among other factors, on the actual wavelengths of the red (R), green (G), and blue (B) beams and the relative intensity of the red, green, and blue beams. In one particular combination, the red, green and blue beams can be combined to provide a beam of white light. One combination of wavelengths that can provide an adequate range of colors, and a neutral white, is a blue wavelength of about 460 (nm), a green wavelength of about 530 nm, and a red wavelength of about 640 nm. It would be advantageous to provide light of about these wavelengths from a single, semiconductor-laser pumped, compact laser apparatus. It would be particularly advantageous if such a source could be provided with adjustable R, G, & B output.

### SUMMARY OF THE INVENTION

The present invention is directed to providing red, green, and blue light from a laser apparatus optically pumped by the blue light. In one aspect, the method comprises providing a beam of plane-polarized blue light. A first praseodymium-doped crystal gain-medium is optically pumped with a first portion of the blue light. The first gain-medium is located in a first resonator arranged to deliver green light. The amount of green light delivered depends on the orientation the polarization plane of the first portion of the blue light with respect to the first gain-medium. A second praseodymium-doped crystal gain-medium is optically pumped with a second portion of the blue light. The second gain-medium is located in a second resonator arranged to deliver red light. The amount of red light delivered depends on the orientation the polarization plane of the second portion of the blue light with respect to the second gain-medium. The polarization plane of at least one of the first portion of the blue light with respect to the first gain-medium and the second portion of the blue light with respect to said second gain-medium is adjusted to adjust relative portions of red and green light delivered. A third portion of the blue light can be combined with the red and green light to provide white light, or light of a particular non-white color, depending on the relative proportions of the red light, the green light, and the blue-light that are combined.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates one preferred embodiment of red, green, and blue laser apparatus in accordance with the present invention, including a semiconductor laser delivering a beam of plane-polarized blue light, with first and second monolithic Pr³⁺:YLF resonators sequentially optically pumped by the beam of blue light, the laser output of the apparatus comprising a portion of the blue light transmitted through the first and second resonators, green light delivered by the first resonator and transmitted through the second resonator, and red light delivered by the second resonator, selectively rotatable polarization rotators being provided for adjusting the amount of blue light pumping, and accordingly red light and green light delivery by the first and second resonators.

FIG. 1A schematically illustrates one alternative embodiment of red, green, and blue laser apparatus in accordance with the present invention, similar to the apparatus of FIG. 1 but wherein the polarization rotators are emitted and gain crystals in the resonators are selectively rotatable with respect to the polarization plane of the blue light for adjusting the amount of blue light pumping, and accordingly red light and green light delivery by the first and second resonators.

FIG. 2 is a graph schematically illustrating absorption as a function of wavelength in a Pr³⁺:YLF crystal for two polarizations orthogonally oriented with respect to the c-axis of the Pr³⁺:YLF crystal.

FIG. 3 is a graph schematically illustrating emission cross-section as a function of wavelength in a Pr³⁺:YLF crystal for the two polarizations of FIG. 2.

FIG. 4 schematically illustrates another preferred embodiment of red, green, and blue laser apparatus in accordance with the present invention, the apparatus having the optical pumping and light-generating sequence of the laser of FIG. 1, but wherein the first and second resonators each include a pair of resonator mirrors with a Pr³⁺:YLF crystal therebetween and separate from the mirrors, and wherein the semiconductor laser is a frequency-doubled, external-cavity, surface-emitting semiconductor laser.

FIG. 5 schematically illustrates yet another preferred embodiment of red, green, and blue laser apparatus in accordance with the present invention, including a semiconductor laser delivering a beam of plane-polarized blue light which is divided along three paths, with blue light in one of the paths optically pumping a Pr³⁺:YLF resonator delivering green light, with blue light in another of the paths optically pumping a Pr³⁺:YLF resonator delivering red light, with blue light in the remaining path being combined with the red light and the green light, and wherein polarization rotators are provided for adjusting the amount of blue-light pumping and accordingly red light and green light delivered.

FIG. 6 schematically illustrates still another preferred embodiment of red, green, and blue laser apparatus in accordance with the present invention, similar to the laser of FIG. 5, but wherein optical pump light is provided by a frequency doubled edge emitting laser, and wherein adjusting the amount of blue light pumping and red light and green light delivered is accomplished by selectively rotating the Pr³⁺:YLF gain-medium in the appropriate resonator about the path of blue light in the resonator.

### DETAILED DESCRIPTION OF THE INVENTION

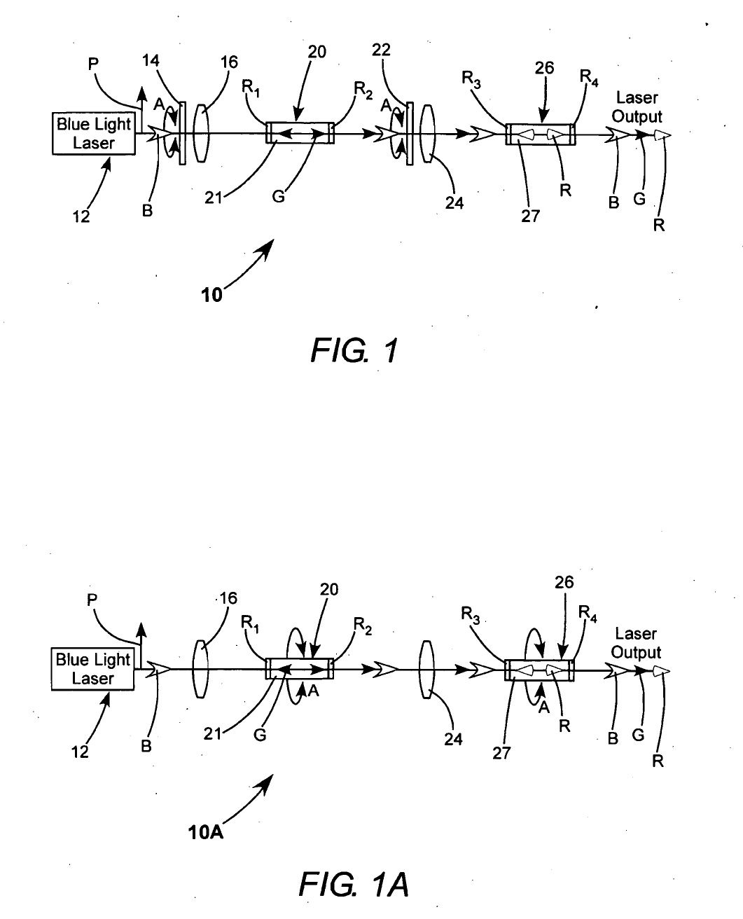

Referring now to the drawings, wherein like components are designated by like reference numerals, FIG. 1 schematically illustrates one preferred embodiment 10 of laser apparatus in accordance with the present invention. Laser 10 includes a laser 12 arranged to deliver blue light, indicated by large open arrowhead B. Laser 12 is preferably a semiconductor laser.

One example of a suitable semiconductor laser is an electrically pumped semiconductor laser having an active layer of gallium nitride (GaN) indium gallium nitride (InₓGa₍₁₋ₓ₎N), indium gallium nitride arsenide (InₓGa₍₁₋ₓ₎N_{y}As_{(1-y)}) or gallium nitride arsenide (GaN_{y}As_{(1-y)}). Another example of a suitable semiconductor laser is a frequency-doubled diode-laser such as an externally frequency-doubled single-mode edge-emitting laser. Such a laser having plane-polarized, single-mode, blue-light output is commercially available from Picarro Inc., of San Jose, Calif.

Yet another example of a suitable semiconductor laser is an optically pumped (semiconductor-laser pumped), external-cavity, intra-cavity frequency-doubled, surface-emitting semiconductor laser. Such a laser is referred to hereinafter simply as a frequency-doubled OPS laser. A surface-emitting heterostructure of such a laser includes a gain-structure having active layers separated by half-wavelengths of the emission wavelength by one or more separator layers. In one example of such a structure, active layers of InₓGa₍₁₋ₓ₎As, can provide an emission (fundamental) wavelength of about 958 nm, which can be intra-cavity frequency doubled to provide an output wavelength of 479 nm. Frequency-doubled OPS-lasers having plane-polarized blue-light output are commercially available from Coherent Inc. of Santa Clara, Calif., the assignee of the present invention.

Other blue-light lasers suitable for use include, but are not limited to, OPS-lasers having a fundamental blue-light output and optically pumped edge-emitting semiconductor lasers having fundamental blue-light output. Examples of fundamental blue-light OPS-lasers are described in detail in U.S. application Ser. No. 10/961,262, filed Oct. 8, 2004 and in U.S. patent application Ser. No. 11/203,734, filed Aug. 15, 2005, assigned to the assignee of the present invention, and the complete disclosure of each of which are hereby incorporated by reference. Examples of fundamental-output, optically pumped, edge-emitting semiconductor lasers are described in U.S. Patent Application No. 2005/0276301, also assigned to the assignee of the present invention, and the complete disclosure of which is also hereby incorporated by reference.

Blue-light output of laser 12 is preferably plane-polarized, for reasons which are discussed further herein below. The polarization vector (electric vector) of light leaving laser 12 is indicated here as being (arbitrarily) in the plane of the drawing. The plane-polarized blue light is passed through a polarization rotator 14, which is arranged to selectively rotate the polarization plane of the blue light by rotating the polarizer about an axis parallel to the propagation direction of the blue light as indicated by arrow A. After traversing polarization rotator 14, the blue light is focused by a lens 16 into a monolithic laser resonator 20. Resonator 20 is formed by a crystal 21 of a gain-medium having a wavelength-selective (multilayer-dielectric) reflector R₁ on one end thereof and a wavelength-selective reflector R₂ on an opposite end thereof. Preferably crystal 21 is a fluoride or oxide crystal doped with trivalent praseodymium (Pr³⁺). One preferred crystal material is praseodymium-doped yttrium lithium fluoride (Pr³⁺:YLF). Other preferred Pr³⁺ doped crystal materials include yttrium aluminum oxides (Pr³⁺:Y₃Al₅O₁₂ and Pr³⁺:YAlO₃), barium yttrium fluoride (Pr³⁺:BaY₂F₈), lanthanum fluoride (Pr³⁺:LaF₃), calcium tungstate (Pr³⁺:CaWO₄), strontium molybdate (Pr³⁺:SrMoO₄), yttrium aluminum garnet (Pr³⁺:YAG), yttrium silicate (Pr³⁺:Y₂SiO₅), yttrium phosphate (Pr³⁺:YP₅O₁₄), lanthanum phosphate (Pr³⁺:LaP₅O₁₄), lutetium aluminum oxide (Pr³⁺:LuAlO₃), lanthanum chloride (Pr³⁺:LaCl₃), lanthanum bromide (Pr³⁺:LaBr₃). Crystals may also include rare-earth dopants in addition to praseodymium. Such additional dopants include erbium (Er³⁺), holmium (Ho³⁺), dysprosium (Dy³⁺), europium (Eu³⁺), samarium (Sm³⁺), promethium (Pm³⁺), neodymium (Nd³⁺), and ytterbium (Yb³⁺)

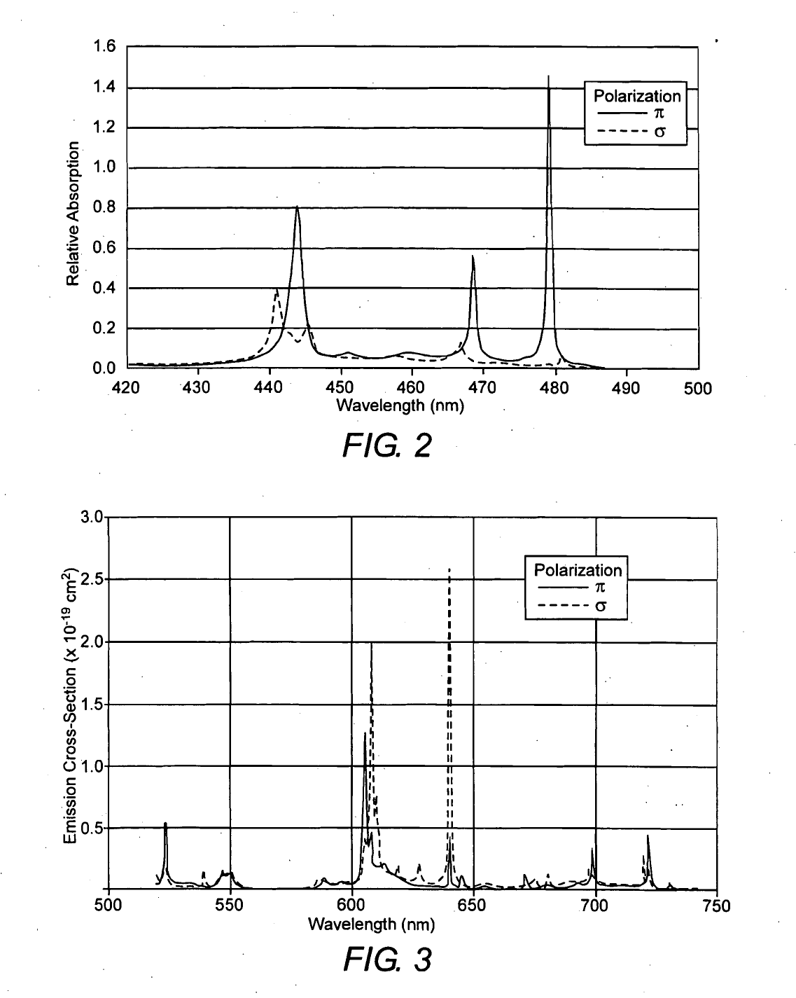

Pr³⁺:YLF has a polarization-dependent absorption spectrum including absorption peaks, for one polarization orientation, at wavelengths of about 444 nm, about 468 nm, and about 479 nm, with weaker absorption peaks for an orthogonally oriented polarization at about 440 nm, about 445 nm, about 451 nm, about 460 nm, and about 467 nm. Any of these wavelengths would be useful as blue light for combination with red light and green light to form white light, or light of a selected color (hue, saturation and brightness). FIG. 2 schematically illustrates the absorption spectra for Pr³⁺:YLF in the two different polarization orientations, in a wavelength range between about 420 nm and 500 nm. A solid curve depicts the absorption spectrum for the spectrum for a polarization orientation wherein the electric vector is oriented parallel to the crystal c-axis (π-orientation), with a dashed curve depicting the spectrum for light with the electric vector oriented perpendicular to the crystal c-axis (σ-orientation). The strong absorption peak at 479 nm makes this wavelength a preferred wavelength for pumping. FIG. 3 schematically illustrates emission cross-section spectra for Pr³⁺:YLF for the polarization orientations of FIG. 2.

Referring again to FIG. 1, preferably, resonator 20 is arranged to generate green light (indicated by solid arrowheads G), responsive to absorption of a portion of the blue light by gain-medium (crystal) 21. Pr³⁺:YLF has a laser transitions (emission wavelengths) at about 522 nm and about 545 nm in the green region of the visible spectrum (see FIG. 3). The 522 nm wavelength is preferred. Layers of reflector R₁, in such a resonator arrangement for generating 522 nm radiation, would be selected to provide maximum reflection, for example, greater than about 99.8% reflection, at the 522 nm wavelength, and maximum transmission for the blue-light wavelength. Layers of reflector R₂ would be selected to provide about 98% reflection and about 2% transmission at the 522 nm wavelength, and maximum transmission for the blue-light wavelength. The naturally higher emission cross-section of the 522 nm transition compared with that of the 545 nm transition will provide that the 522 nm is generated preferentially.

Green light and unabsorbed blue light are delivered from resonator 20 via reflector R₂. The green and blue light pass through another polarization rotator 22 which is also arranged to selectively rotate the polarization plane of the blue light. After traversing polarization rotator 22, the blue light and green light are focused by a lens 24 into a monolithic laser resonator 26. Resonator 26 is formed by a crystal 27 of a gain-medium having a wavelength-selective (multilayer-dielectric) reflector R₃ on one end thereof and a wavelength-selective reflector R₄ on an opposite end thereof. Preferably crystal 27 is a also fluoride or oxide crystal doped with trivalent praseodymium (Pr³⁺), for example, Pr³⁺:YLF as discussed above.

Resonator 26 is arranged to generate red light (indicated in FIG. 1 by small open arrowheads R), responsive to absorption of a portion of the blue light by gain-medium (crystal) 27. Pr³⁺:YLF has a laser transition (emission wavelength) at about 644 nm in the red region of the visible spectrum (see FIG. 3). Layers of reflector R₃, in such a resonator arrangement for generating 644 nm radiation, would be selected to provide maximum reflection at the 644 nm wavelength, and maximum transmission for the blue-light and green-light wavelengths. Layers of reflector R₄ would be selected to provide about 98% reflection and about 2% transmission at the 644 nm wavelength, and maximum transmission for the blue-light and green-light wavelengths. If desired, the resonator could be configured to generate an output at 639.5 nm instead of 644 nm.

Green light, red light, and unabsorbed blue light are delivered from resonator 20 via reflector R₄ as output of the laser apparatus. The relative powers of the red light, green light, and blue light delivered by the inventive laser will depend, among other factors, on the blue-light wavelength selected, the dopant percentage in gain-media 21 and 27, the length of the gain-media, and the polarization orientation of the blue light with respect to the gain-media. The polarization orientation of the light entering the gain-media can be adjusted by selectively rotating optional polarization rotators 14 and 22 about an axis parallel to the propagation direction of the blue light. Alternatively, (see apparatus 10A in FIG. 1A), the polarization rotators may be omitted, and the individual crystals 21 and 27 can be selectively rotated about the propagation direction (resonator axis) to adjust the polarization orientation of the blue light relative to the crystal. Either method of adjusting polarization orientation can be used to vary proportions of red light, green light, and blue light in the laser output. This is useful either for providing an output of a desired color or for adjusting “white balance” when a neutral white light output is desired. Methods and mechanisms for rotating the polarization rotators are well-known in the art and a detailed description thereof is not necessary for understanding principles of the present invention. Accordingly, such a detailed description is not presented herein.

It should be noted, here, that while apparatus 10 is described as delivering red light, green light, and blue light as laser output propagating along a common path, the laser output may also be divided into separate red, green and blue channels by appropriate dichroic beamsplitters as is known in the art. In this way each colour could be individually modulated by means of a modulator, for example, an acousto-optic modulator (AOM) or an interferometric monitor such as a Mach-Zehnder inteferometer. Further, while the resonators 20 and 26 are described as first generating green light then generating red light, the resonators may be arranged, by suitable selection of transmission and reflection values for reflectors R₁, R₂, R₃, and R₄, to first generate red light and then generate green light. Generating green-light first is most preferred, however, as the gain for the green light wavelength is considerably less than that for the red light wavelength. Accordingly, green light is preferably generated in a position in the apparatus where the blue pump light is most intense.

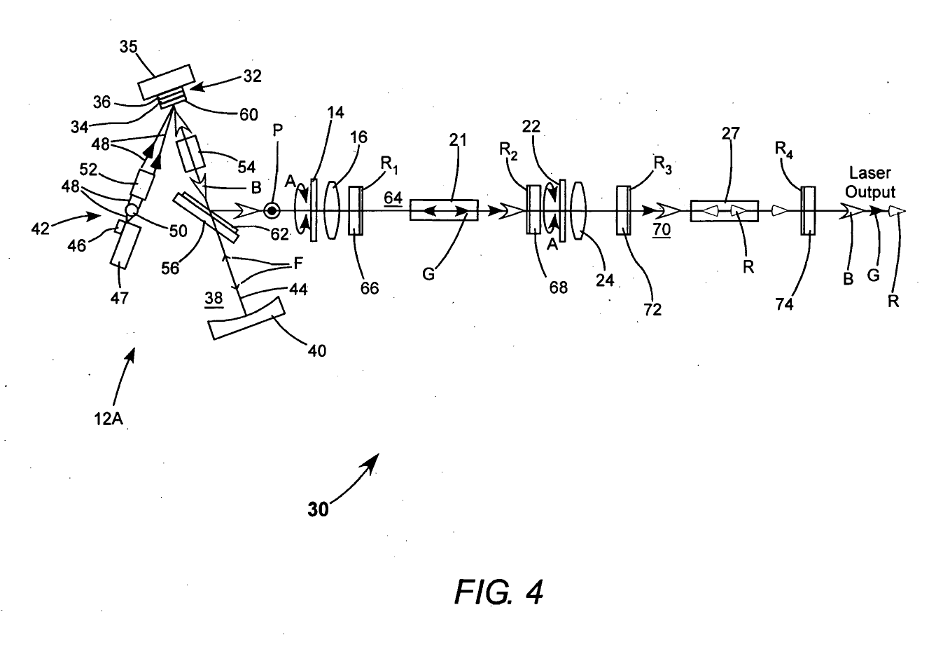

FIG. 4 schematically illustrates another embodiment 30 of laser apparatus in accordance with the present invention. In apparatus 30, blue-light laser 12A is an example of a frequency-doubled OPS laser of the type discussed above. Laser 12A includes an optically-pumped semiconductor laser structure (OPS-structure) 32 including an epitaxially-grown monolithic semiconductor (surface-emitting) gain-structure 34 including a plurality of active layers (not shown) spaced apart by separator-layers (not shown). The gain structure surmounts a Bragg mirror structure 36. OPS-structure 32 is in thermal contact with a substrate or heat-sink 35 via the Bragg mirror-structure.

Gain-structure 34, on being optically pumped, emits laser-radiation in a narrow spectrum of wavelengths, generally defined as a gain-bandwidth of the gain-structure. The gain-bandwidth has a nominal (median) characteristic (fundamental) emission wavelength and corresponding characteristic emission frequency which is dependent, inter alia, on the composition of the active layers. By way of example, for active layers of an InₓGa₍₁₋ₓ₎As_{y}P_{(1-y)} composition emission wavelengths between about 700 and 1100 nm can be achieved by selection of appropriate proportions for x and y. The fundamental wavelength selected should be twice the desired wavelength of the blue light. OPS structures having emission wavelengths in this range are available from Coherent Tutcore OY, of Tampere Finland.

Mirror structure 36 serves as one end-mirror (a plane mirror) for a laser-resonator 38. Another mirror 40, preferably a concave mirror, provides the other end-mirror of laser-resonator 38. Gain-structure 34 of OPS-structure 32 is thereby incorporated in laser-resonator 38. Mirror structure 34 and mirror 40 are highly reflective (for example have a reflectivity of about 99% or greater) for the fundamental (emission) wavelength of gain-structure 34.

A pump-radiation source 42 is arranged to deliver pump-radiation to gain-structure 34 of OPS-structure 32 for generating laser-radiation in laser-resonator 38. Fundamental radiation so generated circulates in laser-resonator 38 generally along resonator axis 44, as indicated by single arrowheads F. Pump-radiation source 42 includes an edge-emitting semiconductor diode-laser 46 or an array of such lasers mounted on a heat sink 47. Pump-light 48 exits diode-laser 46 as a divergent beam and is focused onto OPS-structure 32 by a cylindrical microlens 50 and a radial-gradient-index lens (a SELFOC lens) 52.

An optically-nonlinear crystal 54, arranged for type-I phase-matching, is located in laser-resonator 38 and arranged to double the frequency (half the wavelength) of the fundamental laser-radiation to generate blue light. The axial path of the blue light is indicated in FIG. 3 by large open arrowheads B.

A birefringent filter 56 is located in laser-resonator 38 for selecting the fundamental of the laser-radiation from a gain bandwidth of wavelengths characteristic of the composition of the active layers. The birefringent filter is inclined at an angle (preferably Brewster's angle for the material of the filter) to resonator axis 44, and serves additionally to cause fundamental radiation in the resonator and blue light generated by optically nonlinear crystal 56 to be plane polarized.

OPS-structure 32 has a multilayer optical coating 60 thereon. Coating 60 is highly reflective for blue-light B and highly transmissive for fundamental laser-radiation F and pump-light 48. Optical coating 60 minimizes absorption of second-harmonic radiation in OPS-structure 32 and reflects this second-harmonic radiation back along axis 44 toward birefringent filter 56. Birefringent filter 56 has a coating 62 thereon on a side thereof facing OPS-structure 32. Coating 62 is highly reflective for blue light B in the s-state of polarization, and is highly transmissive for fundamental laser-radiation F in the p-state of polarization. Dichroic coating 62 directs blue-light B out of laser-resonator 38 and prevents significant loss of the 2H-radiation in the birefringent filter. The electric vector of light B is perpendicular to the plane of the drawing as indicated by arrowhead P.

Plane-polarized blue-light output of laser is passed through a polarization rotator 14 and is focused by a lens 16 into a gain-medium (crystal) 21 located in a laser resonator 64. Resonator 64 is formed between reflectors R₁ and R₂ supported on substrates 66 and 68 respectively. Reflectors R₁ and R₂ have the specifications discussed above with respect to FIG. 1 and green light is generated in resonator 64.

Green light and unabsorbed blue light are delivered from resonator 64 via reflector R₂. The green and blue light pass through another polarization rotator 22 which is also arranged to selectively rotate the polarization plane of the blue light. The green light and blue light are focused by lens 24 into a gain-medium (crystal) 27 located in a resonator 70. Resonator 70 is formed between reflectors R₃ and R₄ on substrates 72 and 74, respectively. Reflectors R₃ and R₄ have specifications as discussed above and resonator 70 generates red light responsive to absorption of the blue light in gain-medium 27. Green light, red light, and unabsorbed blue light are delivered from resonator 20 via reflector R₄ as output of the laser apparatus. The relative powers of the red light, green light, and blue light delivered by the inventive laser can be varied by varying the polarization orientation of blue light in the gain-media, as discussed above for providing an output of a desired color or for adjusting “white balance” when a neutral white light output is desired.

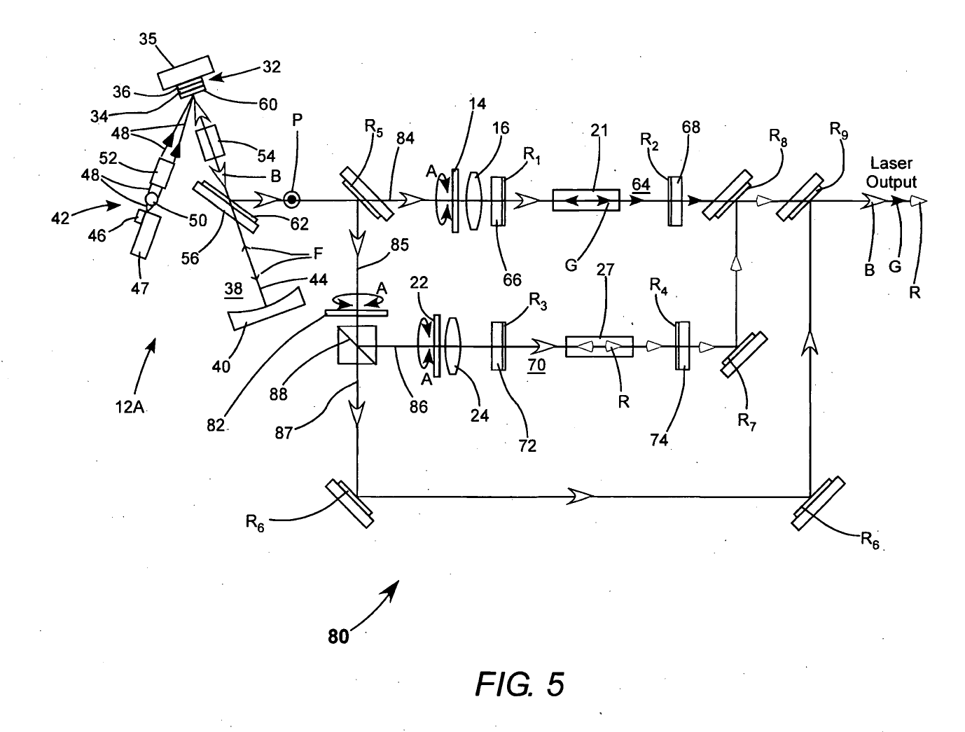

FIG. 5 schematically illustrates yet another preferred embodiment of 80 of laser apparatus in accordance with the present invention. Apparatus 80 is similar to the apparatus of FIG. 4 with an exception that green-light-generating resonator 60 and red-light-generating resonator 70 are optically pumped in parallel. A beamsplitter R₅ divides plane-polarized blue light from frequency-doubled OPS laser 12A into two portions 84 and 85. Portion 84 is directed into resonator 64 for optically pumping gain-medium 21 therein. Portion 85 is directed through a rotatable polarization rotator 82 to a polarizing beamsplitter 88. Beamsplitter 88 divides blue-light portion 85 into two further portions 86 and 87, the relative proportions of which are determined by the polarization orientation of the blue-light at the beamsplitter. Portion 84 is directed into resonator 70 for optically pumping gain-medium 27 therein.

Red-light output of resonator 70 is combined with green-light output of resonator 64 by a turning mirror R₇ and a dichroic combiner R₈. The blue-light portion 87 is combined with the combined red-light and green-light outputs via two turning mirrors R₆ and a dichroic combiner R₉. Relative portions of red light, green light and blue light are adjusted by adjusting the polarization plane of blue light with respect to one or both of the gain-media by selectively rotating one or more of polarization rotators 14, 22, and 82. Brightness of the output can be adjusted by modulating pump-light power from frequency-doubled OPS 12A. Preferably, the doping percentage and the length of gain-media 21 and 27 should be selected such that, at the maximum output of resonators 64 and 70, no blue pump light is transmitted by the gain-media. This minimizes loss of blue light at dichroic combiner R9.

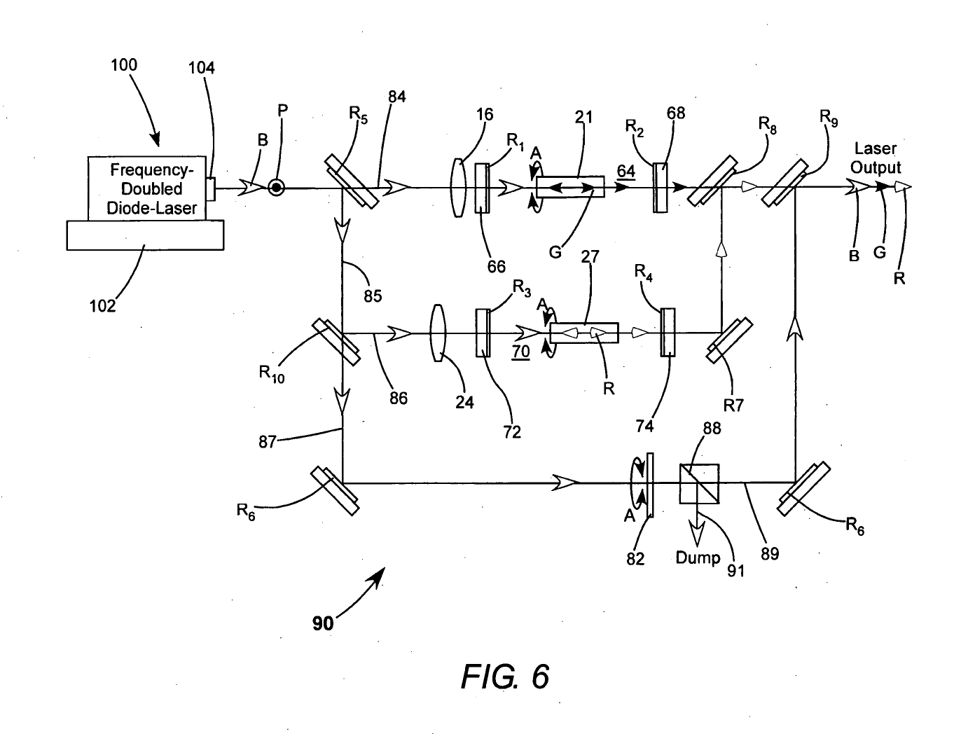

FIG. 6 schematically illustrates still another embodiment 90 of laser apparatus in accordance with the present invention. Laser 90 is similar to laser 80 with exceptions as follows. Frequency-doubled OPS laser 12A of laser apparatus 80 is replaced by a frequency-doubled diode-laser (edge-emitting semiconductor laser) 100. Laser 100 is mounted on a heat sink 102 and emits plane polarized radiation via port 104. Beamsplitter R₁₀ replaces polarizing beamsplitter 88 of apparatus 80 for dividing blue-light portion 85 into portions 86 and 87. Portion 87 of the blue light is directed by a turning mirror R6 through rotatable polarization rotator 82, and through polarizing beamsplitter 88. Portion 89 transmitted by the beamsplitter depends on the selective rotation of polarization rotator 82. Any blue 100 light not transmitted is dumped from the system. Red-light output and green-light output are adjusted by selectively rotating one or both of the gain-media about the direction of incident blue light (thereby adjusting the orientation of the gain-medium with respect to the polarization orientation of the blue light) as indicated by arrows A. An advantage of the arrangement of laser 90 compared with that of laser 80 of FIG. 5 is that red-light output, green-light output, and blue-light output are separately adjustable, provided, of course, that doping and length of the gain-media are arranged such that no blue light is transmitted by the gain-media as discussed above.

From the forgoing description, those skilled in the art may devise other embodiments of the inventive laser apparatus without departing from the spirit and scope of the present invention. Such embodiments may include, for example, different combinations of polarization-dependent selective adjustment of red-light and green-light output, adjustment of blue-light output by selective modulating means other than the polarization rotator and polarizing beamsplitter of apparatus 90. Embodiments of laser 80 and 90 may include, in place of resonators 64 and 70, monolithic resonators, or resonators with one mirror on the gain-medium and the other spaced-apart from the gain-medium. In summary, the present invention is not limited to the embodiments described and depicted herein. Rather, the invention is limited only by the claims appended hereto.

What is claimed is:

1. A method of providing red light and green light, comprising:
providing a beam of plane-polarized blue light;
optically pumping a first crystal gain-medium doped with at least praseodymium with a first portion of said plane-polarized blue light, said first gain-medium being located in a first resonator arranged to deliver green light, the amount of green light delivered depending on the orientation of the polarization plane of said first portion of said blue light with respect to said first gain-medium;
optically pumping a second crystal gain-medium doped with at least praseodymium, with a second portion of said plane-polarized blue light, said second gain-medium being located in a second resonator arranged to deliver red light, the amount of red light delivered depending on the orientation of the polarization plane of said second portion of said blue light with respect to said second gain-medium; and
selectively orienting the polarization plane of at least one of said first portion of said plane-polarized blue light with respect to said first gain-medium, and said second portion of said plane-polarized with respect to said second gain-medium, to adjust relative portions of red and green light delivered.

2. The method of claim 1, wherein a third portion of said beam of plane-polarized blue light is combined with said red light and green light to provide white light.

3. The method of claim 1, wherein said beam of plane-polarized blue light is passed sequentially through said first and second gain-media and said first portion of said blue light is absorbed by said first gain-medium and said second portion of said blue light is absorbed by said second gain-medium.

4. The method of claim 1, wherein said beam of plane-polarized blue light is divided into at least first and second beams of plane-polarized blue light, and said first and second beams of plane-polarized blue light are passed respectively through said first and second gain-media.

5. The method of claim 4, wherein said beam of plane-polarized blue light is divided into first, second, and third beams of plane-polarized blue light, and at least a portion of said third beam of plane-polarized blue light is combined with said red and green light to provide white light.

6. The method of claim 1, wherein said first and second gain-media are selected from the group of praseodymium-doped gain-media consisting of yttrium lithium fluoride, yttrium aluminum oxides, barium yttrium fluoride, lanthanum fluoride, calcium tungstate, strontium molybdate yttrium aluminum garnet, yttrium silicate, yttrium phosphate, lanthanum phosphate, lutetium aluminum oxide, lanthanum chloride, and lanthanum bromide.

7. The method of claim 6, wherein at least one of said first and second gain-media is co-doped with at least one of erbium, holmium, dysprosium, europium, samarium, promethium, neodymium, and ytterbium.

8. The method of claim 6, wherein said first and second gain-media are praseodymium doped yttrium lithium fluoride.

9. The method of claim 8, wherein said plane-polarized blue light has a wavelength which is one of about 440 nm, about 444 nm, about 445 nm, about 451 nm, about 460 nm, about 467 nm, about 468 nm, and about 479 nm.

10. The method of claim 8, wherein said green light has a wavelength of one of about 522 nm and about 545 nm and said red light has a wavelength of about 644 nm.

11. The method of claim 1, wherein said selective polarization-plane orienting step includes locating a polarization rotator in the path of said plane polarized blue light optically pumping said first gain-medium or second gain-medium and rotating the polarization rotator to rotate the polarization orientation of said plane-polarized blue light.

12. The method of claim 1, wherein said selective polarization-plane orienting step includes selectively rotating one of said first and second gain-media about the propagation direction of said plane-polarized blue light optically pumping said gain-medium.

13. A method of providing red light and green light, comprising:
providing a first beam of plane-polarized blue light;
dividing said first beam of plane-polarized blue light into at least second and third beams of plane-polarized blue light;
optically pumping a first praseodymium-doped crystal gain-medium with at least a portion of said second beam of plane plane-polarized blue light, said first gain-medium being located in a first resonator arranged to deliver green light, the amount of green light delivered depending on the orientation of the polarization plane of said portion of said second beam of plane-polarized blue light with respect to said first gain-medium;
optically pumping a second praseodymium-doped crystal gain-medium with at least a portion of said third beam of plane-polarized blue light, said second gain-medium being located in a second resonator arranged to deliver red light, the amount of red light delivered depending on the orientation of the polarization plane of said portion of said third beam of plane-polarized blue light with respect to said second gain-medium; and
selectively orienting the polarization plane of at least one of said second and third beams of plane-polarized blue light blue adjust relative portions of red and green light delivered.

14. The method of claim 13, further wherein said first-beam dividing step includes dividing said first beam of plane-polarized blue light into second, third, and fourth beams of plane-polarized blue light and combining at least a portion of said fourth beam of plane-polarized blue light of with said adjusted relative portions of red and green light to provide white light.

15. The method of claim 14, wherein said portion of said fourth plane-polarized blue light beam is selected by selectively modulating said fourth plane-polarized blue light beam.

16. A method of providing red light and green light, comprising:
providing a beam of plane-polarized blue light;
directing said beam of plane-polarized blue light into a first praseodymium-doped crystal gain-medium, said first gain-medium being located in a first resonator arranged to deliver green light in response to a first portion of said plane-polarized blue light being absorbed by said first gain-medium, the amount of green light delivered depending on the orientation at said gain-medium of the polarization plane of said plane-polarized blue light with respect to said first gain-medium;
directing said delivered green light and a first residual portion of said plane polarized blue light into a second praseodymium-doped crystal gain-medium, said second gain-medium being located in a second resonator arranged to deliver red light in response to a portion of said first residual portion of said plane-polarized blue light being absorbed by second gain-medium, the amount of red light delivered depending on the orientation at said gain-medium of the polarization plane of said first residual portion of said plane-polarized blue light with respect to said second gain-medium;
delivering said red light and said green light from said second resonator along a common path with a second residual portion of said blue light; and
selectively orienting the polarization plane of at least one of said plane-polarized-blue light at said first gain-medium with respect to said first gain-medium, and said first residual portion of said plane-polarized blue light at said second gain-medium with respect to said second gain-medium, to selectively vary proportions of red light, green light, and blue light on said common path.

17. The method of claim 16, wherein said proportions of red light, green light, and blue light on said common path a selectively varied to provide a beam of white light.

18. Laser apparatus comprising:
a laser arranged to generate plane-polarized blue light;
a first laser resonator including a first crystal gain-medium doped with at least praseodymium, said first crystal gain medium having a crystal-axis and being arranged to be optically pumped by a first portion of said plane-polarized blue light, said first laser resonator arranged to deliver green light in response to said optical pumping of said crystal gain-medium;
a second laser resonator including a second crystal gain-medium doped with at least praseodymium, said second crystal gain medium having a crystal-axis and being arranged to be optically pumped by a second portion of said plane-polarized blue light, said second laser resonator arranged to deliver red light in response to said optical pumping of said crystal gain-medium; and
wherein, the polarization orientation of said first portion of said first and second portions of said blue light with respect to said crystal axes of said first and second gain media are selectively adjustable.

19. The apparatus of claim 18, wherein said first and second gain-media are selected from the group of praseodymium-doped gain-media consisting of yttrium lithium fluoride, yttrium aluminum oxides, barium yttrium fluoride, lanthanum fluoride, calcium tungstate, strontium molybdate yttrium aluminum garnet, yttrium silicate, yttrium phosphate, lanthanum phosphate, lutetium aluminum oxide, lanthanum chloride, and lanthanum bromide.

20. The apparatus of claim 18, wherein at least one of said first and second gain-media is co-doped with at least one of erbium holmium, dysprosium, europium, samarium, promethium, neodymium, and ytterbium.

21. The apparatus of claim 18, wherein said first and second gain-media are praseodymium doped yttrium lithium fluoride.

22. The apparatus of claim 21, wherein said crystal axis of said first and second gain media is the c-axis.

23. The apparatus of claim 18, further including an optical arrangement for combining said red and green light delivered by said laser-resonators on a common path with a third portion of said plane-polarized blue light.

24. A laser apparatus comprising:
a first laser resonator having a praseodymium doped gain medium and including wavelength selective optics configured such that the resonator will generate green light when the gain medium is optically pumped:
a second laser resonator having a praseodymium doped gain medium and including wavelength selective optics configured such that the resonator will generate red light when the gain medium is optically pumped;
a source of polarized blue light for optically pumping the first and second laser resonators; and
means for adjusting the polarization orientation of the blue light prior to entering the resonators to control the level of absorption of the light in the respective gain media.

25. A laser apparatus as recited in claim 24, further including optical elements to combine the green light, red light and blue light.
